(19) United States
(12) Patent Application Publication
(10) Pub. No.: US 2023/0415267 A1
(43) Pub. Date: Dec. 28, 2023

(54) CLAD WIRE FEEDSTOCK FOR DIRECTED ENERGY DEPOSITION ADDITIVE MANUFACTURING

(71) Applicant: Essentium IPCO, LLC, Pflugerville, TX (US)

(72) Inventor: Charles Brandon Sweeney, Pflugerville, TX (US)

(21) Appl. No.: 18/359,422

(22) Filed: Jul. 26, 2023

Related U.S. Application Data
(63) Continuation of application No. PCT/US22/13856, filed on Jan. 26, 2022.
(60) Provisional application No. 63/148,999, filed on Feb. 12, 2021.
(60) Provisional application No. 63/143,460, filed on Jan. 29, 2021.

(51) Int. Cl. B23K 26/342; B33Y 70/00; B33Y 10/00; B23K 35/02; B23K 35/28

(52) U.S. Cl. CPC B23K 26/342; B33Y 70/00; B33Y 10/00; B23K 35/0261; B23K 35/286

(57) ABSTRACT

A clad wire feedstock for a directed energy deposition (DED) process is disclosed and includes a core material defining an outer surface and one or more clad metal layers that surround the outer surface of the core material.

### CROSS-REFERENCE TO RELATED APPLICATIONS

This application claims priority to U.S. Application No. 63/143,460 filed on Jan. 29, 2021, and U.S. Application No. 63/148,999 filed Feb. 12, 2021, where the teachings of which are incorporated herein by reference.

### FIELD

The present disclosure is directed to a clad wire feedstock for directed energy deposition (DED) additive manufacturing.

### BACKGROUND

The statements in this section merely provide background information related to the present disclosure and may or may not constitute prior art.

Directed energy deposition (DED) refers to a category of additive manufacturing or three-dimensional printing techniques that involve a feed of powder or wire that is melted by a focused energy source to form a melted or sintered layer on a substrate. Although the focused energy source is usually a laser beam, a plasma arc or an electron beam may be used instead. Current wire-based DED systems employ filament wires that are composed of a single metal or alloy composition. However, employing a filament wire that is composed of a single metal or alloy results in a printed part that is homogenous in composition and structure.

Thus, while current filament wires used in additive manufacturing techniques achieve their intended purpose, there is a need for new and improved filament wires used in DED processes.

### SUMMARY

According to several aspects, a coaxial clad wire feedstock for directed energy deposition (DED) additive manufacturing is disclosed. The clad wire feedstock includes a core material defining an outer surface and one or more clad metal layers that surround the outer surface of the core material.

In an aspect, a method for creating an article by a DED process is disclosed. The method includes melting, by a focused energy beam, a clad wire feedstock. The method also includes depositing the clad wire feedstock onto a substrate that is part of a three-dimensional printer, where the clad wire feedstock includes a core material defining an outer surface and one or more clad metal layers that surround the outer surface of the core material.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 is a schematic diagram of a three-dimensional printer used in a DED process, where the three-dimensional printer employs the disclosed clad wire feedstock;

FIG. 2 is a cross-sectioned view of clad wire feedstock shown in FIG. 1, where the clad wire feedstock includes a clad metal layer and a core material;

FIG. 3 is an enlarged, cross-sectioned view of the article shown in FIG. 1, taken along section line A-A;

FIG. 4 is a cross-sectioned view of another embodiment of the clad wire feedstock where the clad metal layer is constructed of a brazing alloy;

FIG. 5 is a cross-sectioned view of yet another embodiment of the clad wire feedstock where the clad metal layer 242 is constructed of a grain boundary inhibitor;

FIG. 6 is a cross-sectioned view of still another embodiment of the clad wire feedstock where the clad metal layer is constructed of a material that is relatively ductile;

FIG. 7 is a cross-sectioned view of another embodiment of the clad wire feedstock where the clad metal layer acts as an optical energy absorber;

FIG. 8 is a cross-sectioned view of another embodiment of the clad wire feedstock having two or more clad metal layers; and

FIG. 9 is a cross-sectioned view of another embodiment of the clad wire feedstock having multiple layers.

### DETAILED DESCRIPTION

The following description is merely exemplary in nature and is not intended to limit the present disclosure, application, or uses.

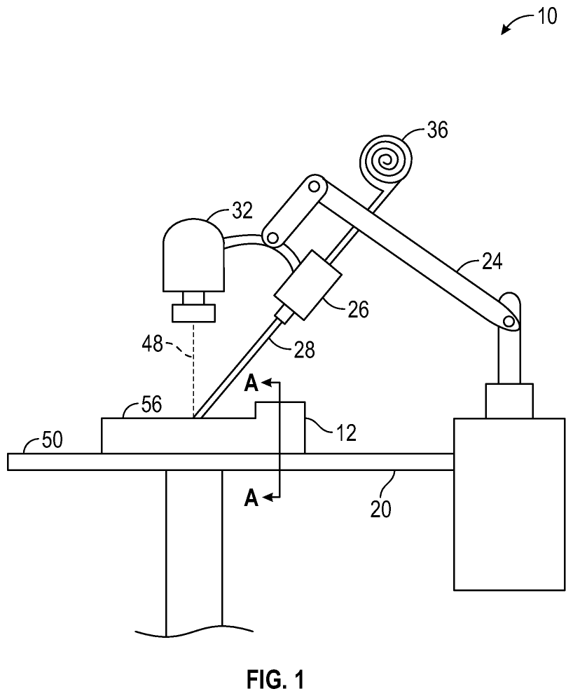

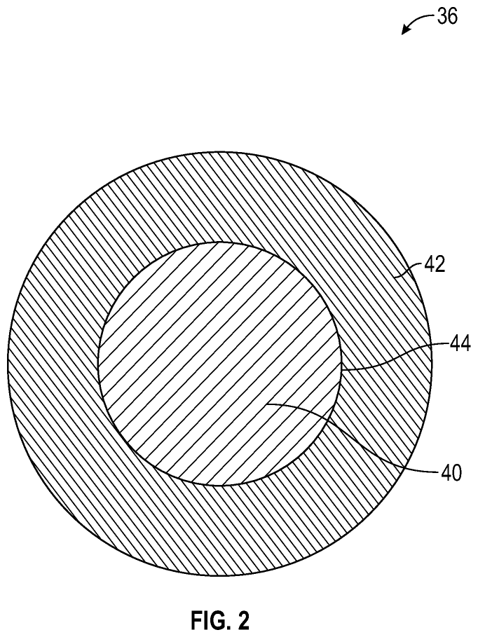

The present disclosure is directed to a clad wire feedstock used in a directed energy deposition (DED) process. Referring now to FIG. 1, a three-dimensional printer 10 for creating an article 12 based on the DED process is illustrated. In the non-limiting embodiment as shown in FIG. 1, the three-dimensional printer 10 includes a substrate 20 for providing support to the article 12, an arm 24, a nozzle 26 configured to deposit a build material 28, and an energy source 32. The build material 28 is in the form of a clad wire feedstock 36. FIG. 2 is a cross-sectioned view of the clad wire feedstock 36, which is constructed of two or more dissimilar materials. Specifically, the clad wire feedstock 36 includes a core material 40 and one or more clad metal layers 42 that extend coaxially and coat an outer surface 44 of the core material 40. As explained in greater detail below, the core material 40 may be any type of metal employed in a DED process and is selected based on the specific application. Referring to both FIGS. 1 and 2, the clad wire feedstock 36 is fed to the nozzle 26, where the nozzle 26 is mounted to the arm 24, which may be a multi-axis arm having four, five, or six axes. As the clad wire feedstock 36 is deposited, a focused energy beam 48 generated by the energy source 32 melts the clad wire feedstock 36 onto either a build surface 50 of the substrate 20 or the article 14. In one embodiment, the focused energy beam 48 is a laser beam, however, in another implementation the focused energy beam 48 may be a plasma arc or an electron beam.

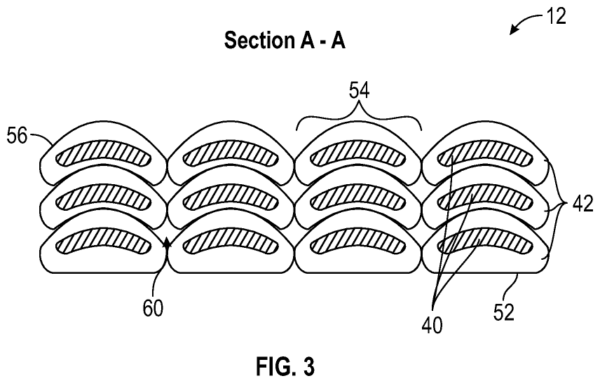

It is to be appreciated that because the clad wire feedstock 36 is constructed of two dissimilar materials, the resulting article 12 created during the deposition process will also have unique properties that would not be possible with a filament wire composed of only a single metal. FIG. 3 is a cross-sectioned view of the article 12 shown in FIG. 1, taken along section A-A. As seen in FIG. 3, even after deposition the clad metal layer 42 continues to surround the core material 40 used for the clad wire feedstock 36 (FIG. 2). That is, the clad metal layer 42 of the clad wire feedstock 36 is disposed at a peripheral boundary 52 of each trace 54 deposited by the three-dimensional printer 10 (seen in FIG. 1). Accordingly, although the article 12 is composed of two different materials, an outer surface 56 of the article 12 is composed of the material used for the clad metal layer 42 of the clad wire feedstock 36.

Referring to FIGS. 1-3, it is to be appreciated that the clad metal layer 42 is configured to persist after a molten bead of the clad wire feedstock 36 has been deposited by the three-dimensional printer 10. That is, the clad metal layer 42 of the clad wire feedstock 36 does not mix with and stays separate from the core material 40 during the deposition process. In order to ensure that the clad metal layer 42 persists during the deposition process, the clad metal layer 42 includes a melt temperature that is different than the melt temperature of the core material 40 of the clad wire feedstock 36 by at least degrees Celsius. Alternatively, the clad metal layer 42 may also have a wettability or surface tension that is sufficiently different than the core material 40 such that the clad metal layer 42 remains intact after the deposition of the molten bead. That is, the surface tension of the one or more clad metal layers differs from a surface tension of the core material 40 by a threshold amount, where the threshold amount ensures the one or more clad metal layers 42 remain intact after depositing the molten bead.

Referring specifically to FIG. 2, the clad wire feedstock 36 may be fabricated using any number of approaches. In one embodiment, the clad wire feedstock 36 starts out as a forming blank that is coated by a shell constructed of the clad metal layer 42. The forming blank is then extruded and drawn down to wire form using drawing dies. Alternatively, in another embodiment, the clad metal layer 42 is applied to the outer surface 44 of the core material 40 using any number of techniques such as, but not limited to, electrodeposition, electroless deposition, physical vapor deposition, and plasma coating.

In one embodiment, the clad metal layer 42 of the clad wire feedstock 36 is constructed of a metal based electrode material. The clad wire feedstock 36 is used to construct the finished article 12 (seen in FIG. 1), which is an electrode used in applications such as, but not limited to, batteries, fuel cells, and electroplating. For example, in one embodiment, the clad metal layer 42 is constructed of a relatively expensive electrode material such as platinum, and the core material 40 is constructed of a less expensive material such as nickel, copper, stainless steel, or tin. This approach may be used in order to reduce the material costs associated with the article 12 (seen in FIG. 1). In another example, the clad metal layer 42 is constructed of aluminum, and the core material 40 is constructed of a metal matrix composite such as aluminum-beryllium, or aluminum-silicon carbide. In another embodiment, the clad metal layer 42 of the clad wire feedstock 36 is constructed of an electrode material that is relatively dense, such as lead. Because materials such as lead are dense and heavy, it may be challenging to fabricate large articles using only lead, as the article may not be able to support its own weight. Accordingly, the core material 40 of the clad wire feedstock 36 is constructed of a different, stronger material having a lower density such as copper, nickel, or steel.

FIG. 4 is another embodiment of the clad wire feedstock 136 where the clad metal layer 142 is constructed of a brazing alloy and the core material 140 is constructed of a material that includes a higher melting temperature than the brazing alloy. As a result, the clad wire feedstock 136 is deposited at the melt temperature of the brazing alloy. This allows for higher-performance materials to be deposited using lower processing temperatures and energy requirements. In one embodiment, the melt temperature of the core material 140 is at least ten percent higher than the melt temperature of the clad metal layer 142. For example, in one embodiment, the clad metal layer 142 is constructed of a brass brazing alloy, which includes a melt temperature of about 450° C., and the core material 40 is constructed of a high strength steel, which includes a melt temperature of about 1450-1510° C.

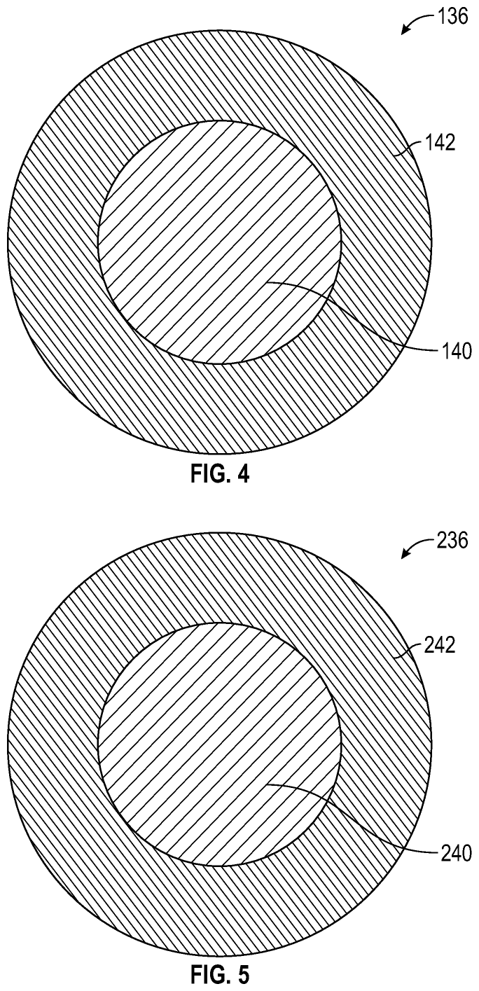

FIG. 5 is yet another embodiment of the clad wire feedstock 236 where the clad metal layer 242 is constructed of a grain boundary inhibitor, and the core material 240 is constructed of a metal that the grain boundary inhibitor controls. The grain boundary inhibitor is configured to inhibit grain growth of the core material 240 once the clad wire feedstock 236 has been deposited, especially around an interface 60 (seen in FIG. 3) between each trace 54 of deposited material. The smaller grain structure results in a core material 240 that has enhanced hardness and increased wear resistance. In one embodiment, the core material 240 is constructed of tungsten carbide (WC) with a metal binder such as cobalt (Co), nickel (Ni) or iron (Fe) and the grain growth inhibitors are titanium carbide (TiC), vanadium carbide (VC), molybdenum carbide (Mo₂C) or tantalum carbide (TaC).

FIG. 6 is another embodiment of the clad wire feedstock 336 where the clad metal layer 342 is constructed of a material that is relatively ductile so as to be drawn into a wire, while the core material 340 is constructed of a material that is relatively brittle and is not easily drawn into wire form. Accordingly, the core material 340 is constructed of a relatively brittle material that would not typically be used in a wire. For example, in one embodiment, the clad metal layer 342 is constructed of aluminum or an aluminum alloy, and the core material 340 is a metal matrix composite such as aluminum-beryllium, or aluminum-silicon carbide. Another example would be a clad metal layer 342 constructed of a ductile tool steel alloy, and the core material 340 is a high carbon, hard and brittle tool steel.

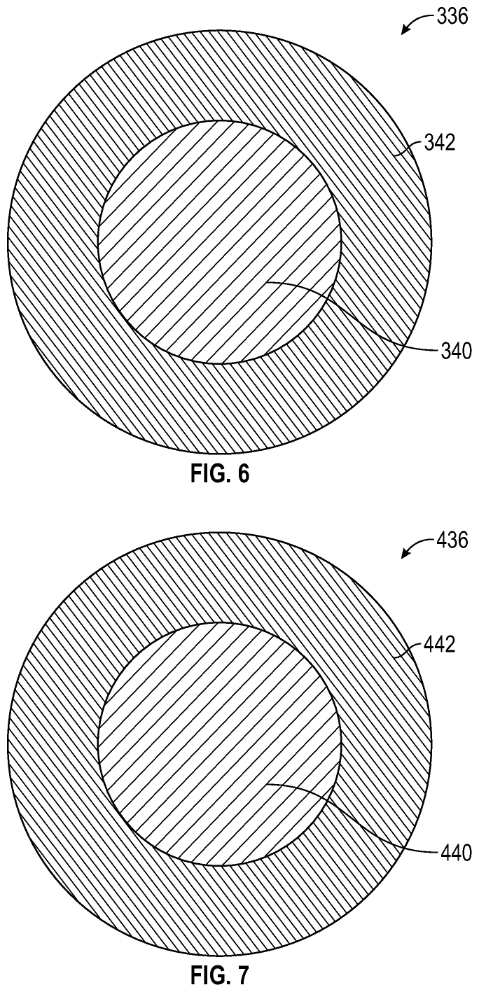

FIG. 7 is yet another embodiment of the clad wire feedstock 436 where the clad metal layer 442 acts as an optical energy absorber that is configured to absorb a specific wavelength of light. The light may be in the ultraviolet, visible, or infrared spectrum. In this embodiment, the core material 440 may be constructed of a material that does not effectively absorb the specific wavelength of light. The specific wavelength of light represents the wavelength of the focused energy beam 48 (FIG. 1). Accordingly, specific material used for the clad metal layer 442 depends on the specific wavelength used for the focused energy beam 48. For example, in one embodiment, the focused energy beam 48 is a laser source having a blue wavelength, the core material 440 is aluminum, and the clad metal layer 442 is copper. It is to be appreciated that copper absorbs substantially more energy from light having a blue wavelength when compared to aluminum.

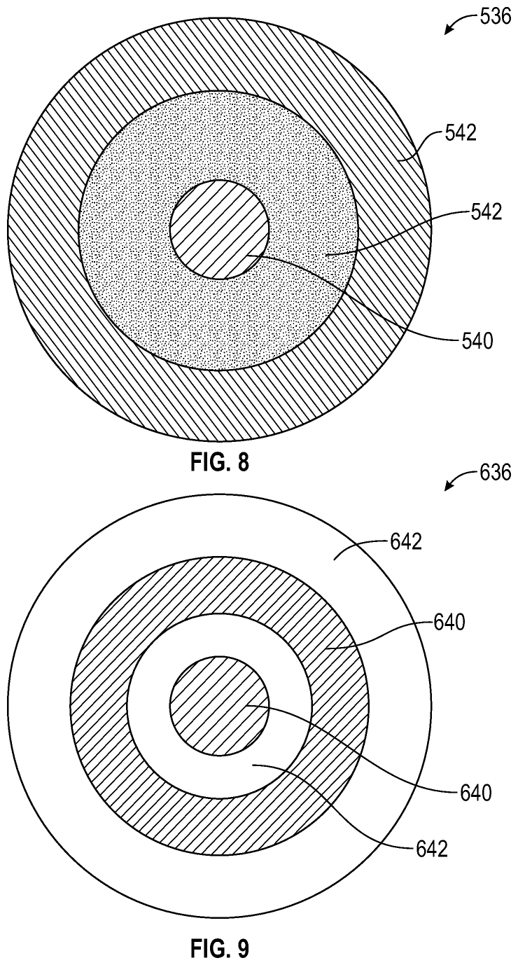

FIG. 8 is yet another embodiment of the clad wire feedstock 536 including the core material 540 and two or more clad metal layers 542 that surround the core material 540. In this embodiment the article 12 (FIG. 1) contains a bimetallic microstructure which could enable the material to have a Seebeck coefficient, making the article 12 act as a thermocouple, thermoelectric device, or a bimetallic strip actuator. Although FIG. 8 illustrates the clad wire feedstock 536 having three layers total, it is to be appreciated that FIG. 8 is merely exemplary in nature and the clad wire feedstock 536 may include any number of layers. For example, in the embodiment as shown in FIG. 9, the clad wire feedstock 636 includes four layers, where the core material 640 is alternated between layers of the clad metal layer 642. In the example as shown in FIG. 9, the clad metal layer 642 is constructed of a grain boundary inhibitor, and the core material 640 is constructed of a metal that the grain boundary inhibitor controls. Although a grain boundary inhibitor is described, it is to be appreciated that other types of materials may be used as well for the clad metal layer 642. For example, in another embodiment the clad metal layer 642 is constructed of a material that is ductile, and the core material 640 is constructed of a material that is relatively brittle and is not easily drawn into wire form.

Referring generally to the figures, the disclosed clad wire feedstock provides various technical effects and benefits. Specifically, the clad wire feedstock allows for an article to include a single type of metal or alloy disposed along its outermost surface, however, the article is constructed of two or more different materials. In contrast, current filament wires are composed of a single metal or alloy, which results in an article that is homogenous in structure and composition.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A clad wire feedstock for a directed energy deposition (DED) process, the clad wire feedstock comprising:
a core material defining an outer surface; and
one or more clad metal layers that surround the outer surface of the core material.

2. The clad wire feedstock of claim 1, wherein the one or more clad metal layers are configured to persist after a molten bead of clad wire feedstock has been deposited, and the one or more clad metal layers stays separate from the core material during the DED process.

3. The clad wire feedstock of claim 2, wherein the one or more clad metal layers includes a melt temperature that is different from a melt temperature of the core material by at least ten degrees Celsius.

4. The clad wire feedstock of claim 2, wherein a surface tension of the one or more clad metal layers differs from a surface tension of the core material by a threshold amount, and wherein the threshold amount ensures the one or more clad metal layers remain intact after depositing the molten bead.

5. The clad wire feedstock of claim 1, wherein the one or more clad metal layers are constructed of platinum and the core material is constructed of at least one of nickel, copper, stainless steel, and tin.

6. The clad wire feedstock of claim 1, wherein the one or more clad metal layers are constructed of aluminum and the core material is constructed of a metal matrix composite.

7. The clad wire feedstock of claim 1, wherein the one or more clad metal layers are constructed of a brazing alloy.

8. The clad wire feedstock of claim 7, wherein the core material is constructed of a material including a higher melting temperature when compared to the brazing alloy.

9. The clad wire feedstock of claim 8, wherein a melting temperature of the core material is at least ten percent higher than the melt temperature of the one or more clad metal layers.

10. The clad wire feedstock of claim 1, wherein the one or more clad metal layers are constructed of a grain boundary inhibitor.

11. The clad wire feedstock of claim 10, wherein the core material is constructed of a metal that the grain boundary inhibiter controls.

12. The clad wire feedstock of claim 11, wherein the grain growth inhibitors are one or more of the following: titanium carbide (TiC), vanadium carbide (VC), molybdenum carbide (Mo₂C), and tantalum carbide (TaC).

13. The clad wire feedstock of claim 11, wherein the core material (240) is constructed of tungsten carbide (WC) with a metal binder.

14. The clad wire feedstock of claim 1, wherein the clad metal layer is constructed of aluminum or an aluminum alloy, and the core material is a metal matrix composite.

15. The clad wire feedstock of claim 1, wherein the clad metal layer acts as an optical energy absorber configured to absorb a specific wavelength of light.

16. The clad wire feedstock of claim 15, wherein the light is in the ultraviolet, visible, or infrared spectrum.

17. The clad wire feedstock of claim 15, wherein the core material is constructed of aluminum and the clad metal layer is constructed of copper.

18. The clad wire feedstock of claim 1, wherein the clad wire feedstock includes two or more clad metal layers that surround the core material.

19. A method for creating an article by a DED process, the method comprising:
melting, by a focused energy beam, a clad wire feedstock; and
depositing the clad wire feedstock onto a substrate that is part of a three-dimensional printer, wherein the clad wire feedstock includes a core material defining an outer surface and one or more clad metal layers that surround the outer surface of the core material.

20. The method of claim 19, wherein the one or more clad metal layers are configured to persist after a molten bead of clad wire feedstock has been deposited, and the one or more clad metal layers stays separate from the core material during the DED process.
